(19) United States
(12) Patent Application Publication
(10) Pub. No.: US 2016/0148202 A1
(43) Pub. Date: May 26, 2016

(54) Methods and Systems for Processing Transactions, Based on Transaction Credentials

(71) Applicant: MASTERCARD ASIA PACIFIC PTE. LTD., SINGAPORE (SG)

(72) Inventors: Brian McCormack, New South Wales (AU); Donghao Huang, Singapore (SG); Yvette Oh, Singapore (SG); Andreas Spycher, Singapore (SG); Kathy Chang Koh, Singapore (SG); Mohamad Hafidz Mohd Fadzil, Singapore (SG); Carol Lim, Singapore (SG); Gerald Sun, Singapore (SG); Klein Wang, Singapore (SG); Yong How Chin, Singapore (SG)

(21) Appl. No.: 14/951,832

(22) Filed: Nov. 25, 2015

(30) Foreign Application Priority Data
Nov. 26, 2014 (SG) 10201407849W

(51) Int. Cl. G06Q 20/38; G06Q 20/08

(52) U.S. Cl. CPC G06Q 20/3821; G06Q 20/085

(57) ABSTRACT

Various embodiments provide a transaction method comprising determining, by a server, if a transaction device is registered to a service, the transaction device being one of a plurality of transaction devices selectable to initiate a transaction, the plurality of transaction devices being associated with at least one transaction credential; determining, by the server, if the transaction device is selected to initiate the transaction based on the determination if the transaction device is registered to the service; and processing, by the server, the transaction using the associated at least one transaction credential if the transaction device is determined to be selected to initiate the transaction.

### FIELD

The present disclosure relates broadly, but not exclusively, to a transaction method using a transaction credential that is associated with a transaction device, and related systems.

### BACKGROUND

This section provides background information related to the present disclosure which is not necessarily prior art.

Payment cards, such as credit cards and debit cards, are commonly used in the retail environment for the purchase of goods and/or services. Such cards are popular with consumers, and merchants accept these cards as a necessary part of doing business, i.e., they provide an effective substitute to cash and checks.

However, it is often necessary for a consumer to provide a credit card or details of the credit card at the time of purchase. This poses inconvenience for consumers who own several payment cards for various types of transactions. Also, this poses security issues because it requires the customers to present important banking information relevant to the payment cards.

These payment card transactions are typically performed across multiple channels of commerce. For example, payment card based transactions may be performed in person at a retail outlet, via a computer connected to the internet, via a mobile phone and/or via a company-based call centre. These various transactions are conducted in different ways and, accordingly, have different levels of fraud risk associated therewith. In addition, the mentioned transactions generally require that the consumer have his or her card in hand to either present to the cashier in a retail environment, or to enter the requested information via the internet and/or over the telephone along with the provision of confidential information such as account information.

There is therefore a need in the art for a method and system for processing a transaction using a common device, without having to provide a payment card or details relating to a payment card.

### SUMMARY

This section provides a general summary of the disclosure, and is not a comprehensive disclosure of its full scope or all of its features. Aspects and embodiments of the disclosure are also set out in the accompanying claims.

Various embodiments provide a transaction method comprising determining, by a server, if a transaction device is registered to a service, the transaction device being one of a plurality of transaction devices selectable to initiate a transaction, the plurality of transaction devices being associated with at least one transaction credential; determining, by the server, if the transaction device is selected to initiate the transaction based on the determination if the transaction device is registered to the service; and processing, by the server, the transaction using the associated at least one transaction credential if the transaction device is determined to be selected to initiate the transaction.

In an embodiment, the determination, by the server, if the transaction device is registered to the service is performed in response to receiving a transaction request message, the transaction request message comprising an indicator indicating whether the transaction device is subscribed to the service.

In an embodiment, the method further comprises requesting confirmation, by the server, that the transaction device is selected to initiate the transaction if the indicator indicates that the transaction device is subscribed to the service.

In an embodiment, the confirmation is requested, by the server, based on transaction data indicating a type of the transaction.

In an embodiment, the transaction device is determined, by the server, to be selected to initiate the transaction only if the transaction data indicates that the type is a predetermined type.

In an embodiment, the transaction device is determined, by the server, to be selected to initiate the transaction only if the transaction device data indicates that the transaction device is selected to initiate the transaction based on the transaction data.

In an embodiment, the method further comprises determining, by the server, if a merchant is registered to the service.

In an embodiment, the method further comprises determining, by the server, if the merchant is selected to process the transaction.

In an embodiment, the transaction is processed, by the server, using the associated at least one transaction credential if the merchant is determined to be selected to process the transaction.

In an embodiment, the transaction device is selected based on a transaction criteria and the transaction is processed, by the server, in accordance with the transaction criteria when the transaction device is determined to be selected to initiate the transaction.

In an embodiment, the transaction criteria is determined by an owner of the transaction credential via the server.

In an embodiment, the determination of the transaction criteria via the server includes determining a threshold amount for each transaction.

In an embodiment, a holder of the transaction device is different from an owner of the transaction credential.

In an embodiment, the transaction device comprises any one or more of a communication device, an electrical appliance and apparel.

In an embodiment, the transaction is a payment transaction.

In an embodiment, the plurality of transaction devices correspond to an identifier.

In an embodiment, the identifier is a unique internet protocol address.

In an embodiment, the determination if the transaction device is registered to a service is based on cryptography techniques.

In an embodiment, the determination if the transaction device is selected to initiate the transaction is based on cryptography techniques.

Various embodiments provide a proxy server comprising at least one processor; and at least one memory including computer program code; the at least one memory and the computer program code configured to, with the at least one processor, cause the proxy server at least to: determine if a transaction device is registered to a service, the transaction device being one of a plurality of transaction devices selectable to initiate a transaction, the plurality of transaction devices being associated with at least one transaction credential; determine if the transaction device is selected to initiate the transaction based on the determination if the transaction device is registered to the service; and process the transaction using the associated at least one transaction credential if the transaction device is determined to be selected to initiate the transaction.

Various embodiments provide a computer-readable storage medium having stored thereon computer program code which when executed by a computer causes the computer to execute a method in accordance with any of the above embodiments.

Various embodiments provide a computer program comprising software code adapted to perform a method in accordance with any of the above embodiments.

Further areas of applicability will become apparent from the description provided herein. The description and specific examples and embodiments in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

Embodiments of the disclosure will be better understood and readily apparent to one of ordinary skill in the art from the following written description, by way of example only, and in conjunction with the drawings, in which:

FIG. 1 illustrates a block diagram of a transaction system within which transaction using a transaction device can be implemented.

FIG. 2 shows a flow chart illustrating a method for conducting a transaction between a merchant and a customer according to an example embodiment.

FIG. 3 shows a block diagram of a server for communicating with a plurality of transaction devices shown in FIG. 1.

FIG. 4(a) shows a schematic diagram illustrating registering a plurality of transaction devices to an account under a service by a payment facilitator.

FIG. 4(b) shows a schematic diagram illustrating determining a transaction criteria for the holders of the transaction devices under a service by a payment facilitator.

FIG. 5 shows an exemplary computing device to realize a server for the payment network server shown in FIG. 1.

FIG. 6 illustrates a schematic of a payment server 108 of FIG. 1.

### DETAILED DESCRIPTION

Example embodiments will now be described more fully with reference to the accompanying drawings.

Some portions of the description which follows are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “scanning”, “calculating”, “determining”, “replacing”, “generating”, “initializing”, “processing”, “outputting”, or the like, refer to the action and processes of a computer system, or similar electronic device, that manipulates and transforms data represented as physical quantities within the computer system into other data similarly represented as physical quantities within the computer system or other information storage, transmission or display devices.

The present specification also discloses apparatus for performing the operations of the methods. Such apparatus may be specially constructed for the required purposes, or may comprise a general purpose computer or other device selectively activated or reconfigured by a computer program stored in the computer. The algorithms and displays presented herein are not inherently related to any particular computer or other apparatus. Various general purpose machines may be used with programs in accordance with the teachings herein. Alternatively, the construction of more specialized apparatus to perform the required method steps may be appropriate. The structure of a conventional general purpose computer will appear from the description below.

In addition, the present specification also implicitly discloses a computer program, in that it would be apparent to the person skilled in the art that the individual steps of the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the disclosure.

Furthermore, one or more of the steps of the computer program may be performed in parallel rather than sequentially. Such a computer program may be stored on any computer readable medium. The computer readable medium may include storage devices such as magnetic or optical disks, memory chips, or other storage devices suitable for interfacing with a general purpose computer. The computer readable medium may also include a hard-wired medium such as exemplified in the Internet system, or wireless medium such as exemplified in the GSM mobile telephone system. The computer program when loaded and executed on such a general-purpose computer effectively results in an apparatus that implements the steps of one or more of the methods herein.

Some disclosed embodiments can also be used in non-financial electronic transactions (e.g. transactions that do not involve monetary payment in exchange for goods and/or services). An example of a non-financial electronic transaction is the redemption of customer loyalty rewards (e.g. frequent flyer miles, credit card points).

For example, information which promotes redemption with a particular merchant can be provided to a transaction device based on the past redemption data relating to a previous redemption. In this way, the holder of the transaction device holder can be informed of promotions that are of interest to them.

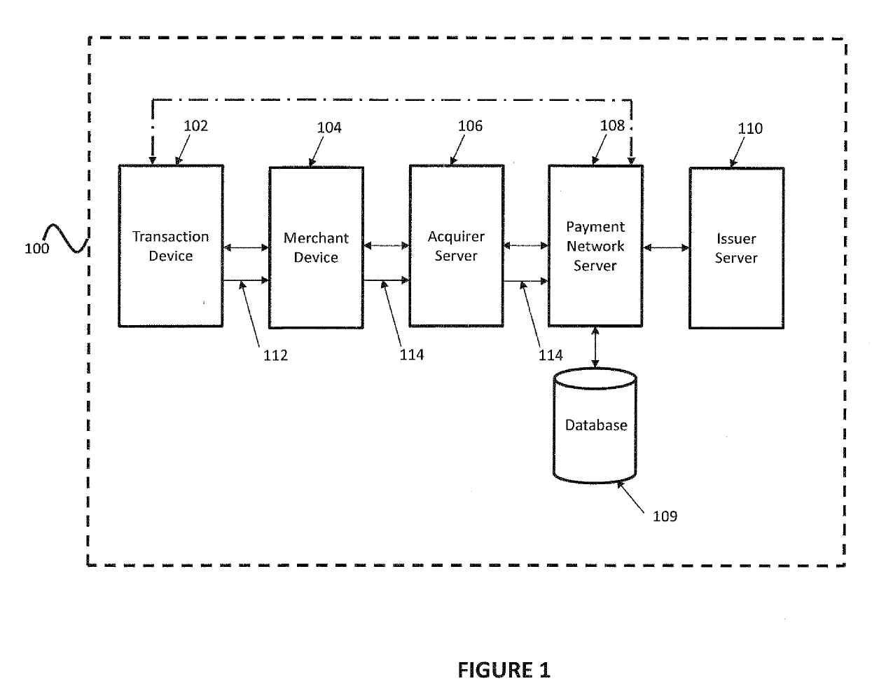

FIG. 1 illustrates a block diagram of a transaction system 100 within which transactions using a transaction device can be implemented.

The system 100 comprises a transaction device 102 in communication with a merchant device 104. The transaction device 102 may also be in direct communication with a payment network server 108, without having to communicate with the merchant device 104.

The merchant device 104 is in communication with an acquirer server 106. The acquirer server 106, in turn, is in communication with a payment network server 108. The payment network server 108, in turn, is in communication with an issuer server 110.

Use of the term ‘server’ herein can mean a single computing device or a plurality of interconnected computing devices which operate together to perform a particular function. That is, the server may be contained within a single hardware unit or be distributed among several or many different hardware units.

The transaction device 102 typically is associated with a customer who is a party to a transaction that occurs between the transaction device 102 and the merchant device 104 through a transaction request message 112. In one implementation, the transaction device 102 is used to initiate such a transaction. The transaction device 102 may be a fixed (wired) computing device or a wireless (portable) computing device. In specific implementations, the transaction device 102 may be a handheld or portable or mobile device carried or used by the customer, or may refer to other types of electronic devices such as a personal computer, a land-line telephone, an interactive voice response (IVR) system, a refrigerator or may refer to apparel such as a watch, a cap and the like. The transaction device 102 may be a device, such as a mobile phone, a laptop computer, a personal digital computer (PDA), a mobile computer, a portable music player (such as an iPod™ and the like).

The merchant device 104 typically is associated with the merchant who is also a party to the transaction that occurs between transaction device 102 and the merchant device 104 through the transaction request message 112. The merchant device 104 may be a point-of-sale (POS) terminal, an automatic teller machine (ATM), a personal computer, a computer server (hosting a website, for example), an IVR system, a land-line telephone, or any type of mobile device such as a mobile phone, a personal digital assistant (PDA), a laptop computer, a tablet computer and the like.

The acquirer server 106 generally is associated with an acquirer who may be an entity (e.g. a company or organization) which issues (e.g. establishes, manages, administers) a transaction credential or an account (e.g. a financial bank account) of the merchant. Examples of the acquirer include a bank and/or other financial institution. As stated in the above, the acquirer server 106 may include one or more computing devices that are used to establish communication with another server by exchanging messages with and/or passing information to the other server.

The payment network server 108 typically is associated with a payment facilitator. For example, the payment network server 108 may be the Banknet® network operated by MasterCard®. The payment facilitator (e.g. MasterCard®) may be an entity (e.g. a company or organization) who operates to process transactions, clear and settle funds for payments between two entities (e.g. two banks). The payment network server 108 may include one or more computing devices that are used for processing transactions.

The issuer server 110 generally is associated with an issuer and may include one or more computing devices that are used to perform a payment transaction. The issuer may be an entity (e.g. a company or organization) which issues (e.g. establishes, manages, administers) a transaction credential or an account (e.g. a financial bank account). An account may be associated with a plurality of transaction devices 102. An owner of the transaction credential may or may not be a holder of the transaction device 102. In other words, a customer who is a holder of the transaction device 102 may or may not be the owner of the account used for the transaction.

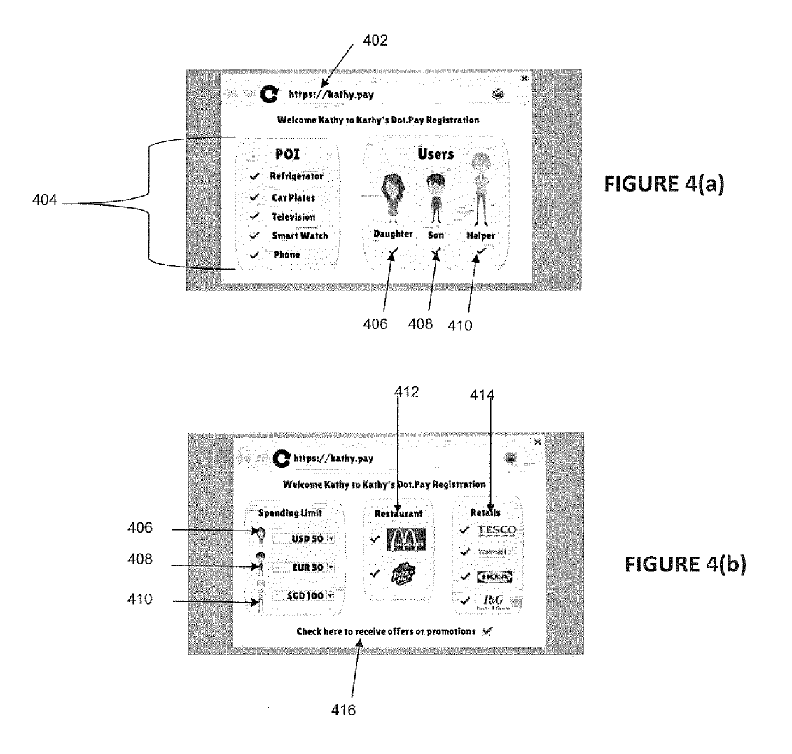

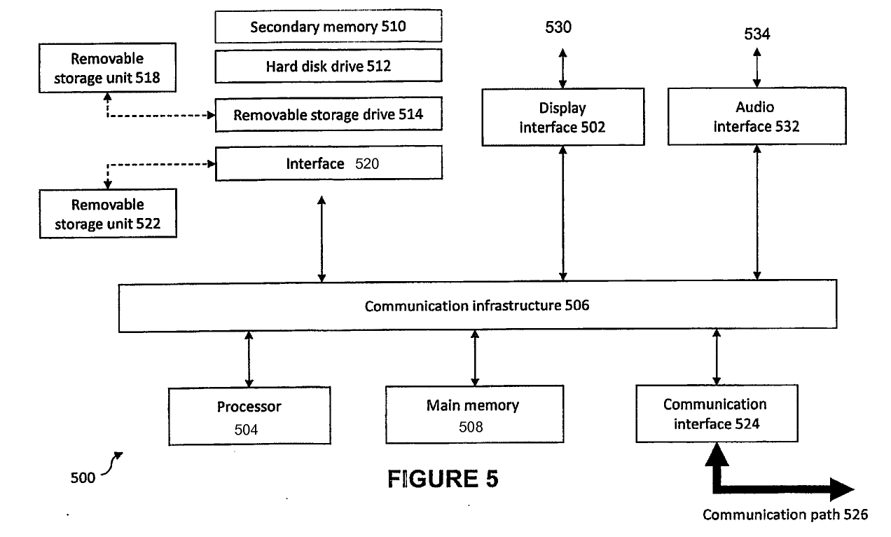

The payment network server 108 may be configured to communicate with, or may include, a database 109. The database 109 stores data corresponding to each account issued by the issuer. Examples of the data include a password, an account owner name and address, a credit limit, data relating to the transaction devices. For example, data relating registering a transaction device 102 and the determining a transaction criteria of the transaction device 102 are included in the database 109. Further details on these data are described in FIGS. 4 and 5 below.

In an example, during a transaction, the transaction request message 112 is generated at the transaction device 102. The transaction request message 112 is generated by the transaction device 102 in response to the customer making a selection of a good and/or service to be purchased from the merchant. Therefore, the transaction request message 112 relates to a transaction between the customer and the merchant. The transaction may be performed via a website of the merchant.

In specific implementations, the transaction device 102 may be fitted with a wireless communications interface such as a Near Field Communication (NFC) interface to enable the transaction device 102 to electronically communicate with the merchant device 104 to perform the transaction. The transaction device 102 may be a piece of apparel, such as a watch that is NFC-enabled. In one implementation, the customer may use the watch to perform the transaction with the merchant by scanning the watch at the merchant device 104. The watch may also generate a token with its secret key and send it to the merchant device 104. In response to receiving the token with the secret key from the transaction device 102, the merchant device 104 may verify these messages and complete the transaction. NFC is a set of standards to establish radio communication between devices by bringing them into close proximity such as only a few centimetres. NFC standards cover communication protocols and data exchange formats, and are based on radio-frequency identification (RFID) technology.

The transaction device 102 is capable of wireless communication using a suitable protocol with the merchant device 104. For example, embodiments may be implemented using transaction devices 102 that are capable of communicating with WiFi/Bluetooth-enabled merchant devices 104. It will be appreciated by a person skilled in the art that depending on the wireless communication protocol used, appropriate handshaking procedures may need to be carried out to establish communication between the transaction device 102 and the merchant device 104. For example, in the case of Bluetooth communication, discovery and pairing of the transaction device 102 and the merchant device 104 may be carried out to establish communication. The transaction device 102 may be a car that is Bluetooth-enabled. In one implementation, the customer may drive to a fast food restaurant to order food. The merchant device 104 located at the fast food restaurant may be able to detect the car via the Bluetooth protocol and send a request message to the customer for approval to perform the transaction using the car. The request message from the merchant device 104 may be sent to a screen installed in the car via which the customer may give his approval to proceed to perform the transaction. The car may then generate a token with its secret key and send it to the merchant device 104.

The transaction request message 112 may include an indicator relating to the transaction device 102 and/or transaction data. The indicator indicates if the transaction device 102 is subscribed to a service such as one provided by a payment facilitator with the payment network server 108 providing the infrastructure to host the service. The service provides a repository where records are kept of transaction devices that are authorized to initiate a specific transaction. Subscribers to the services, such as a customer or a merchant, may select one or more transaction devices 102 and then specify which of these transaction devices are selected to initiate a corresponding transaction. Records of such selections can be kept in the repository. For instance, a first transaction device 102, such as a watch, can be selected to initiate a first type of transaction, such as to make a purchase below $10 at a fast food restaurant. In another instance, another transaction device 102, such as a refrigerator, can be selected to initiate a second type of transaction, such as to make a purchase below $100 at a supermarket.

In an implementation, a transaction is triggered when the selected transaction device 102 is presented at a merchant who also subscribes to this service. A transaction request message 112 is also generated when a transaction is triggered. The service also has a record on the one or more accounts that are linked to the one or more transaction devices 102, under which the transaction costs are billed.

The service leverages existing Secure Socket Layer (SSL) encryption functionality and provides enhanced security through authentication of the customer. A participating account owner and merchant are those who subscribe to the service. As a subscriber to the service, a secret key may be stored in the transaction device 102 and the merchant device 104. Since the role of the payment network server 108 is to facilitate communication, it is able to decrypt the secret key included in the transaction device 102 and the merchant device 104. The service may further leverage a database or repository for storing details of transaction devices that are registered to initiate a transaction. This service is described in greater detail in FIGS. 4(a) and 4(b).

Each transaction data relates to a transaction and identifies the customer and the merchant, generally by way of identifiers of each associated with the customer and merchant respectively. Further, the transaction data may also identify the goods and/or services to be purchased and a type or nature of the transaction. The transaction data may further identify a value or price of the goods and/or services. The transaction data may also indicate a time and date at which the transaction was initiated.

The transaction request message 112 is sent from the transaction device 102 to the merchant device 104. In a disclosed embodiment, for example, where the transaction is being performed at the website of the merchant, the transaction device 102 and the merchant device 104 are in communication with a network, such as, the Internet (not shown for the sake of simplicity). In this example, the transaction request message 112 is sent from the transaction device 102 to the merchant device 104 via the network.

A request message 114 may be generated at the merchant device 104 which acts to request the issuer at the issuer server 110 to authorize or perform the transaction. In a disclosed embodiment, the request message 114 is a payment request message or a modified transaction request message. The transaction is done via the Internet and the request message 114 may include merchant data. The merchant data indicates whether the merchant is subscribed to the service.

The request message 114 is sent from the merchant device 104 to the acquirer server 106. In other words, the request message 114 indicates if the customer and the merchant are subscribed to the service.

The request message 114 is forwarded from the acquirer server 106 to the payment network server 108. The acquirer server 106 may not conduct any processing on or with the request message 114 and, instead, may merely receive the request message 114 from the merchant device 104 and forward it to the payment network server 108.

The request message 114 is received at the payment network server 108. In this way, the payment network server 108 is informed of the transaction and that the merchant would like to obtain authorization of the transaction. The payment network server 108 determines if the transaction device 102 and/or the merchant device 104 are subscribed to the service based on the indicator and the merchant data.

The payment network server 108 may request confirmation that the transaction device 102 is selected to initiate the transaction if the indicator in the request message 114 indicates that at least the same transaction device 102 is subscribed to the service. In a disclosed embodiment, this may be done based on a type of the transaction indicated in the transaction data in the transaction request message 112. For example, the transaction device 102 may be registered to initiate a transaction that occurs at a fast food restaurant.

As mentioned above, the role of the payment network server 108 is to facilitate communication between the acquirer server 106 and the issuer server 110. Therefore, the payment network server 108 may serve as a means through which the acquirer server 106 may communicate with the issuer server 110 in order that payments and authentication may be performed. In specific implementations, the payment network server 108 may not forward the request message 114 to the issuer server 110 to process the transaction if the transaction device 102 and/or the merchant device 104 are not subscribed to the service.

The transaction data included in the transaction request message 112 can also be used to approve the transaction only if there are sufficient funds in an account, or a credit limit of a credit account has been not been exceeded. For example, the transaction data may comprise a transaction amount and the payment network server is operable to determine what funds are available in an account corresponding to the account data and to send the authorization data to the controller only if the funds available are equal to or greater than the transaction amount.

The payment network server 108 may also verify if the transaction device 102 is registered to a service and/or selected to initiate the transaction based on cryptography techniques. For example, in order to verify if the transaction device 102 is registered to a service and/or selected to initiate the transaction, a verification message or a payment token may be received on a token device issued by the payment network server 108 or the transaction device 102. For example, the issuer may generate and send a one-time-password to the token device belonging to the holder of the transaction device. The holder of the transaction device may then enter this one-time-password via another means, e.g. a website, to complete the authentication process. The payment network server 108 then confirms the input of the holder of the transaction device.

For example, a transaction may be initiated by the transaction device 102 (e.g. a watch) that is Bluetooth-enabled. This triggers the merchant device 104 which is also Bluetooth-enabled to send a payment request message to the transaction device 102 via a Bluetooth connection. The transaction device 102 then sends a message to the proxy network server 108 a request for a payment token by using its secret key (e.g., 827SL9282JSHDJ929SJSJ). The proxy network server 108 authenticates the transaction device 102 based on the secret key. If the transaction device 102 is authenticated to be a subscriber of a service, the proxy network server 108 sends the requested payment token to the transaction device 102 which then forwards it to the merchant device 104. With the payment token, the merchant device 104 starts the transaction by requesting payment from the acquirer server 106 via the payment network server 108. In return, the payment network server 108 sends a notification to each of the transaction device 102 and the merchant device 104 informing if the transaction has been successful.

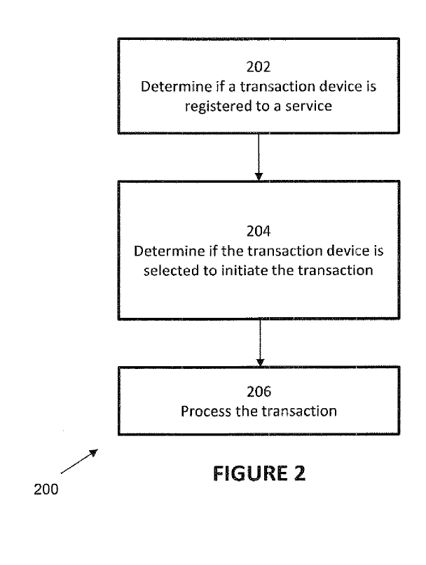

With reference to FIG. 2, there is provided a method of conducting a transaction between a merchant and a customer. The method (designated generally as reference numeral 200) comprises the following steps:

Step 202: Determine if a transaction device 102 is registered to a service.

For example, a transaction device 102 can be used by a holder of the transaction device 102 to initiate a transaction by selecting a good and/or service which will generate a transaction request message 112. The transaction device 102 is one of a plurality of transaction devices that can be associated with one or more accounts. The transaction request message 112 will be sent to the payment network server 108, either directly or indirectly via the merchant device 104 and the acquirer server 106, to determine if the transaction device 102 is registered to the service described above that provides a repository for transaction devices 102 usable to authorize a transaction. This can be done by identifying an indicator included in the transaction request message 112. The indicator is used to indicate whether the transaction device is registered to the service.

Step 204: Determine if the transaction device 102 is selected to initiate the transaction.

Following step 202, the next step is to determine if the transaction device 102 is selected to initiate the transaction. In an embodiment, a determination step is carried out to find out if the transaction device 102 is selected to initiate the transaction if the transaction device 102 is determined to be registered to the service of step 202. This may be done at the payment network server 108 which accesses the database 109 for data relating to the transaction device 102. The transaction device 102 is registered prior to initiating the transaction. At the time of registering the transaction device 102, the owner of the account may select the type of the transaction and a credit amount that the transaction device 102 is authorized to transact.

Step 206: Process the transaction.

Following step 204, the next step is to process the transaction if it is determined that the transaction device 102 is selected to initiate the transaction. In order to process the transaction, the payment network server 108 may forward the request message 114 from the merchant device 104 to the issuer server 110 to obtain payment from the account associated with the transaction device 102.

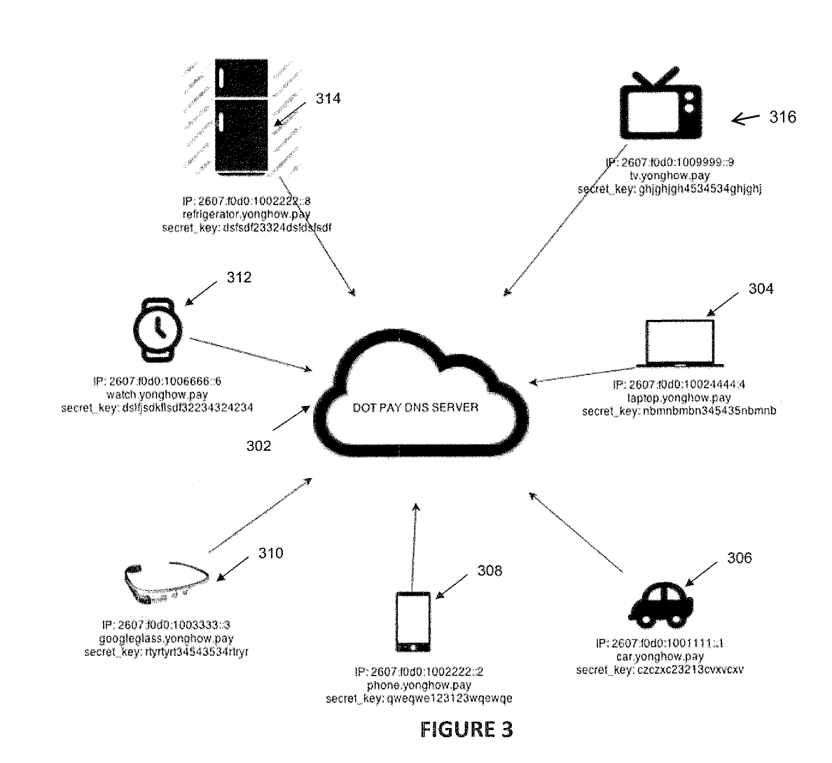

FIG. 3 provides a server 302 for communicating with a plurality of transaction devices shown in FIG. 1. The server 302 may correspond to the payment network server 108 shown in FIG. 1.

In specific implementations, the plurality of transaction devices may be registered to be associated with one or more accounts. The plurality of transaction devices may be a laptop 304, a car 306, a mobile phone 308, a pair of google glasses 310, a watch 312, a refrigerator 314 and a television 316. The plurality of transaction devices is assigned with an unique identifier to identify them as being associated with the same account or accounts. For example, all of these transaction devices may be registered to associate to an account belonging to an owner called “Yonghow” and are assigned with an identifier “yonghow.pay”.

Each of these transaction devices is assigned an unique address such as an internet protocol (IP) address (e.g. a public IPv6 address). For example, the laptop 304 is assigned an IP address of 2607:f0d0:10024444:4 and the television 316 is assigned an IP address of 2607:f0d0:1009999;;9.

FIG. 4(a) provides a schematic diagram of how the transaction devices may be registered to an account under the service. The account may be given a unique address 402 indicative of the account owner, for example “https://kathy.pay/” indicating that that the account owner is “Kathy”.

The account owner may register a plurality of transaction devices 404 (Refrigerator, Car Plates, Television, Smart Watch, Telephone) to be associated with the account. The plurality of transaction devices 404 may also be known as point of interaction (or “POI”). Additionally, the account owner may also register or authorize the respective holders (Daughter 406, Son 408 and Helper 410) of the plurality of transaction devices 404 to initiate transactions using the account. An unique secret key may also be set up for each transaction device 404. Advantageously, this allows messages such as a transaction request message 112 to be encrypted using the unique secret key.

FIG. 4(b) provides a schematic diagram of how the transaction criteria may be determined for the holders of the transaction devices under the service.

The account owner may determine a transaction credit which each holder of the transaction device may be authorised to use. For example, it may be determined that Daughter 406 is authorized to spend USD 50, Son 408 is authorized to spend EUR 50 and Helper 410 is authorized to spend SGD 100. As it is shown, it may also be possible to indicate the currency in which the holder of the transaction device is authorized to spend. This will allow the account owner, Kathy, to authorize a user (e.g., her daughter) to complete purchases up to a limit even when she is in another country (e.g. studying abroad).

Alternatively, instead of determining the transaction credit based on the holder of the transaction device, it is possible to determine the transaction credit based on the transaction device. For example, it may also be possible to determine that the Refrigerator is authorized to process a transaction with a transaction limit of USD 50 and the Television is authorized to process a transaction with a transaction limit of EUR 50.

The account owner may also determine the merchants with whom the holders of the transaction devices may transact. For example, it may be determined that the Daughter 406, Son 408 and Helper 410 are authorized to transact with certain restaurants 412 such as MacDonald's® and Pizza Hut® and certain retailers 414 such as TESCO®, Walmart®, Ikea® and P&G®. In other words, the transaction device is determined to initiate the transaction only if the transaction is a predetermined type.

The account owner may even put restrictions on some holders of the transaction devices. In other words, the account owner, Kathy, may include a restriction on a holder of the transaction device, Son 408. For example, when Son 408 initiates a transaction at MacDonald®'s using his watch, Kathy may be informed on a separate device (e.g. her mobile phone) and the transaction will only process if Kathy approves.

These data relating to the transaction devices are stored in the database 109 shown in FIG. 1. This allows the payment network server 108 to access the database 109 to obtain information, e.g., requesting confirmation that the transaction device 102 is selected to initiate the transaction.

This allows account owners to register trusted merchants with whom they transact frequently or trust to buy goods and/or services. This capability also allows the merchants to create a better relationship with their consumers and recognize their customers by identifying the unique IP address of each transaction device 102. This further allows the merchants to develop targeted marketing activities like promotions and personalized consumer loyalty programs. For example, a link 416 may be provided to present promotions and personalized consumer loyalty programs to the account owner.

FIG. 5 depicts an exemplary computing device 500 where one or more such computing devices 500 may be used for the acquirer server 106, the payment network server 108 or the issuer server 110. The following description of the computing device 500 is provided by way of example only and is not intended to be limiting.

As shown in FIG. 5, the example computing device 500 includes a processor 504 for executing software routines. Although a single processor is shown for the sake of clarity, the computing device 500 may also include a multi-processor system. The processor 504 is connected to a communication infrastructure 506 for communication with other components of the computing device 500. The communication infrastructure 506 may include, for example, a communications bus, cross-bar, or network.

The computing device 500 further includes a main memory 508, such as a random access memory (RAM), and a secondary memory 510. The secondary memory 510 may include, for example, a hard disk drive 512 and/or a removable storage drive 514, which may include a floppy disk drive, a magnetic tape drive, an optical disk drive, or the like. The removable storage drive 514 reads from and/or writes to a removable storage unit 518 in a well-known manner. The removable storage unit 518 may include a floppy disk, magnetic tape, optical disk, or the like, which is read by and written to by removable storage drive 514. As will be appreciated by persons skilled in the relevant art(s), the removable storage unit 518 includes a computer readable storage medium having stored therein computer executable program code instructions and/or data.

In an alternative implementation, the secondary memory 510 may additionally or alternatively include other similar means for allowing computer programs or other instructions to be loaded into the computing device 500. Such means can include, for example, a removable storage unit 522 and an interface 520. Examples of a removable storage unit 522 and interface 520 include a program cartridge and cartridge interface (such as that found in video game console devices), a removable memory chip (such as an EPROM or PROM) and associated socket, and other removable storage units 522 and interfaces 520 which allow software and data to be transferred from the removable storage unit 522 to the computing device 500.

The computing device 500 also includes at least one communication interface 524. The communication interface 524 allows software and data to be transferred between computing device 500 and external devices via a communication path 526. In various disclosed embodiments, the communication interface 524 permits data to be transferred between the computing device 500 and a data communication network, such as a public data or private data communication network. The communication interface 524 may be used to exchange data between different computing devices 500 which such computing devices 500 form a part of an interconnected computer network. Examples of a communication interface 524 can include a modem, a network interface (such as an Ethernet card), a communication port, an antenna with associated circuitry and the like. The communication interface 524 may be wired or may be wireless. Software and data transferred via the communication interface 524 are in the form of signals which can be electronic, electromagnetic, optical or other signals capable of being received by communication interface 524. These signals are provided to the communication interface 524 via the communication path 526.

As shown in FIG. 5, the computing device 500 further includes a display interface 502 which performs operations for rendering images to an associated display 530 and an audio interface 532 for performing operations for playing audio content via associated speaker(s) 534.

As used herein, the term “computer program product” may refer, in part, to removable storage unit 518, removable storage unit 522, a hard disk installed in hard disk drive 512, or a carrier wave carrying software over communication path 526 (wireless link or cable) to communication interface 524. A computer readable medium can include magnetic media, optical media, or other recordable media, or media that transmits a carrier wave or other signal. These computer program products are devices for providing software to the computing device 500. Computer readable storage medium refers to any non-transitory tangible storage medium that provides recorded instructions and/or data to the computing device 500 for execution and/or processing. Examples of such storage media include floppy disks, magnetic tape, CD-ROM, DVD, Blu-ray Disc™, a hard disk drive, a ROM or integrated circuit, USB memory, a magneto-optical disk, or a computer readable card such as a PCMCIA card and the like, whether or not such devices are internal or external of the computing device 500. Examples of transitory or non-tangible computer readable transmission media that may also participate in the provision of software, application programs, instructions and/or data to the computing device 500 include radio or infra-red transmission channels as well as a network connection to another computer or networked device, and the Internet or Intranets including e-mail transmissions and information recorded on Websites and the like.

The computer programs (also called computer program code) are stored in main memory 508 and/or secondary memory 510. Computer programs can also be received via the communication interface 524. Such computer programs, when executed, enable the computing device 500 to perform one or more features of embodiments discussed herein. In various embodiments, the computer programs, when executed, enable the processor 504 to perform features of the above-described embodiments. Accordingly, such computer programs represent controllers of the computing device 500.

Software may be stored in a computer program product and loaded into the computing device 500 using the removable storage drive 514, the hard disk drive 512, or the interface 520. Alternatively, the computer program product may be downloaded to the computing device 500 over the communications path 526. The software, when executed by the processor 504, causes the computing device 500 to perform functions of embodiments described herein.

It is to be understood that the embodiment of FIG. 5 is presented merely by way of example. Therefore, in some embodiments one or more features of the computing device 500 may be omitted. Also, in some embodiments, one or more features of the computing device 500 may be integrated. Additionally, in some embodiments, one or more features of the computing device 500 may be split into one or more component parts.

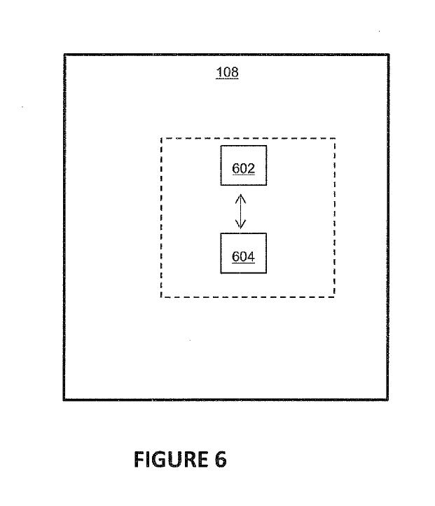

FIG. 6 illustrates a schematic of a proxy server 108 of FIG. 1. The payment network server (or proxy server) 108 may be generally described as a physical device comprising at least one processor 602 and at least one memory 604 including computer program code. The at least one memory and the computer program code are configured to, with the at least one processor, cause the physical device to perform the operations above.

For example, the method of FIG. 2 may be implemented as software and stored in a non-transitory fashion in the secondary memory 510 or the removable storage units 518, 522 of the computer device 500.

It will be appreciated by a person skilled in the art that numerous variations and/or modifications may be made to the present disclosure as shown in the specific embodiments without departing from the spirit or scope of the disclosure as broadly described. For example, the above description mainly discusses the use of a Bluetooth connection, but it will be appreciated that another type of secure wireless connection, such as Wi-Fi, can be used in alternate embodiments to implement the method. Also, the above description mainly discusses how a transaction may be implemented in a transaction system, but it will be appreciated that there are other parties who may be involved, for example, developers. The developers are those who develop at least one component of the transaction system, for example the payment network server 108 and design the transaction system according to specific requirements. The present embodiments are, therefore, to be considered in all respects to be illustrative and not restrictive.

As described, the functions and/or steps and/or operations described herein, in some embodiments, may be described in computer executable instructions stored on a computer readable media (e.g., in a physical, tangible memory, etc.), and executable by one or more processors. The computer readable media is a non-transitory computer readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

Further, it should be appreciated that one or more aspects of the present disclosure transform a general-purpose computing device into a special-purpose computing device when configured to perform the functions, methods, and/or processes described herein.

With that said, exemplary embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

In addition, the exemplary embodiments herein are only examples, and are not intended to limit the scope, applicability, operation, or configuration of the disclosure in any way. It will be further appreciated by a person skilled in the art that numerous variations and/or modifications may be made to one or more of the above-described embodiments without departing from the spirit or scope of the disclosure as broadly described in the appended claims. The above-described embodiments are, therefore, to be considered in all respects to be illustrative and not restrictive.

The terminology used herein is for the purpose of describing particular exemplary embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. As described above, the method steps, processes, and operations described herein are not to be construed as necessarily requiring their performance in the particular order discussed or illustrated, unless specifically identified as an order of performance. It is also to be understood that additional or alternative steps may be employed. As used herein, the term “and/or” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

1. A transaction method comprising:
determining, by a server, if a transaction device is registered to a service, the transaction device being one of a plurality of transaction devices selectable to initiate a transaction, the plurality of transaction devices being associated with at least one transaction credential;
determining, by the server, if the transaction device is selected to initiate the transaction based on the determination if the transaction device is registered to the service; and
processing, by the server, the transaction using the associated at least one transaction credential if the transaction device is determined to be selected to initiate the transaction.

2. The transaction method according to claim 1, wherein the determination, by the server, if the transaction device is registered to the service is performed in response to receiving a transaction request message, the transaction request message comprising an indicator indicating whether the transaction device is subscribed to the service.

3. The transaction method according to claim 2, further comprising requesting confirmation, by the server, that the transaction device is selected to initiate the transaction if the indicator indicates that the transaction device is subscribed to the service;
wherein the confirmation is requested, by the server, based on transaction data indicating a type of the transaction.

4. (canceled)

5. The transaction method according to claim 3, wherein the transaction device is determined, by the server, to be selected to initiate the transaction only if the transaction data indicates that the type is a predetermined type; and/or
wherein the transaction device is determined, by the server, to be selected to initiate the transaction only if the transaction device data indicates that the transaction device is selected to initiate the transaction based on the transaction data.

6. (canceled)

7. The transaction method according to claim 1, further comprising determining, by the server, if a merchant is registered to the service.

8. The transaction method according to claim 7, further comprising determining, by the server, if the merchant is selected to process the transaction;
wherein the transaction is processed, by the server, using the associated at least one transaction credential if the merchant is determined to be selected to process the transaction.

9. (canceled)

10. The transaction method according to claim 1, wherein the transaction device is selected based on a transaction criteria and the transaction is processed, by the server, in accordance with the transaction criteria when the transaction device is determined to be selected to initiate the transaction.

11. The transaction method according to claim 10, wherein the transaction criteria is determined by an owner of the transaction credential via the server; and
wherein the determination of the transaction criteria via the server includes determining a threshold amount for each transaction.

12. (canceled)

13. The transaction method according to claim 1, wherein a holder of the transaction device is different from an owner of the transaction credential; and/or
wherein the transaction device comprises any one or more of a communication device, an electrical appliance and apparel; and/or
wherein the transaction is a payment transaction; and/or
wherein the plurality of transaction devices correspond to an identifier, and the identifier is a unique internet protocol address; and/or
wherein the determination if the transaction device is registered to a service is based on cryptography techniques; and/or
wherein the determination if the transaction device is selected to initiate the transaction is based on cryptography techniques.

14.-19. (canceled)

20. A proxy server comprising:
at least one processor; and
at least one memory including computer program code;
the at least one memory and the computer program code configured to, with the at least one processor, cause the proxy server at least to:
determine if a transaction device is registered to a service, the transaction device being one of a plurality of transaction devices selectable to initiate a transaction, the plurality of transaction devices being associated with at least one transaction credential;
determine if the transaction device is selected to initiate the transaction based on the determination if the transaction device is registered to the service; and
process the transaction using the associated at least one transaction credential if the transaction device is determined to be selected to initiate the transaction.

21. The proxy server according to claim 20, wherein the determination if the transaction device is registered to the service is performed in response to receiving a transaction request message, the transaction request message comprising an indicator indicating whether the transaction device is subscribed to the service.

22. The proxy server according to claim 21, wherein the at least one memory and the computer program code is further configured with the at least one processor to cause the proxy server to request confirmation that the transaction device is selected to initiate the transaction if the indicator indicates that the transaction device is subscribed to the service.

23. The proxy server according to claim 22, wherein the confirmation is requested based on transaction data indicating a type of the transaction.

24. The proxy server according to claim 23, wherein the transaction device is determined to be selected to initiate the transaction only if the transaction data indicates that the type is a predetermined type; and/or
wherein the transaction device is determined to be selected to initiate the transaction only if the transaction device data indicates that the transaction device is selected to initiate the transaction based on the transaction data.

25. (canceled)

26. The proxy server according to claim 20, wherein the at least one memory and the computer program code is further configured with the at least one processor to cause the proxy server to determine if a merchant is registered to the service.

27. The proxy server according to claim 26, wherein the at least one memory and the computer program code is further configured with the at least one processor to cause the proxy server to determine if the merchant is selected to process the transaction; and
wherein the transaction is processed using the associated at least one transaction credential if the merchant is determined to be selected to process the transaction.

28. (canceled)

29. The proxy server according to claim 20, wherein the transaction device is selected based on a transaction criteria and the transaction is processed in accordance with the transaction criteria if the transaction device is determined to be selected to initiate the transaction;
wherein the transaction criteria is determined by an owner of the transaction credential; and
wherein the determination of the transaction criteria includes determining a threshold amount for each transaction.

30. (canceled)

31. (canceled)

32. The proxy server according to claim 20, wherein a holder of the transaction device is different from an owner of the transaction credential; and/or
wherein the transaction device comprises any one or more of a communication device, an electrical appliance and apparel; and/or
wherein the transaction is a payment transaction.

33. (canceled)

34. (canceled)

35. The proxy server according to claim 20, wherein the plurality of transaction devices correspond to an identifier; and
wherein the identifier is a unique internet protocol address.

36. (canceled)

37. The proxy server according to claim 20, wherein the determination if the transaction device is registered to a service is based on cryptography techniques; and/or
wherein the determination if transaction device is selected to initiate the transaction is based on cryptography techniques.

38. (canceled)

39. A computer-readable storage medium having stored thereon computer program code which, when executed by a computer, causes the computer to:
determine if a transaction device is registered to a service, the transaction device being one of a plurality of transaction devices selectable to initiate a transaction, the plurality of transaction devices being associated with at least one transaction credential;
determine if the transaction device is selected to initiate the transaction based on the determination if the transaction device is registered to the service; and
process the transaction using the associated at least one transaction credential if the transaction device is determined to be selected to initiate the transaction.

40. (canceled)
